(19) United States
(12) Patent Application Publication
(10) Pub. No.: US 2026/0173049 A1
(43) Pub. Date: Jun. 18, 2026

(54) 100 MHZ TRANSMISSION

(71) Applicant: QUALCOMM Incorporated, San Diego, CA (US)

(72) Inventors: Jialing Li CHEN, San Diego, CA (US); Lin YANG, San Diego, CA (US); Eugene BAIK, Sunnyvale, CA (US); Bin TIAN, San Diego, CA (US); Sameer VERMANI, San Diego, CA (US); Tevfik YUCEK, San Jose, CA (US)

(21) Appl. No.: 18/986,663

(22) Filed: Dec. 18, 2024

(51) Int. Cl. H04W 72/0453

(52) U.S. Cl. CPC H04W 72/0453

(57) ABSTRACT

This disclosure provides methods, components, devices and systems for 100 MHz transmission. Some aspects more specifically relate to 100 MHz transmission in a defined bandwidth in which a 160 MHz PPDU is supported. In some examples, based on the country code in a beacon frame indicating a country in which a 160 MHz PPDU is supported within a defined bandwidth, wireless communications devices may communicate 100 MHz transmissions within the defined bandwidth. For example, the 100 MHz transmission may be within the lower 100 MHz band of the 160 MHz defined bandwidth. In various aspects, the 100 MHz transmission may include an 80 MHz subband in the lower 80 MHz subband of the 160 MHz PPDU bandwidth and a 20 MHz subband in the upper 80 MHz subband of the 160 MHz PPDU bandwidth. In some aspects, the defined bandwidth may be the 5735 MHz to 5895 MHz band.

### TECHNICAL FIELD

This disclosure relates generally to wireless communication and, more specifically, to 100 MHz transmission.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless communications device. The method may include communicating a beacon frame indicative of a country code associated with a 160 MHz physical layer protocol data unit (PPDU) bandwidth within a defined bandwidth, communicating, in association with the country code, frequency resource allocation information for a 100 MHz transmission within the 160 MHz PPDU bandwidth, the 100 MHz transmission including an 80 MHz subband and a 20 MHz subband, and transmitting a payload of the 100 MHz transmission in accordance with the frequency resource allocation information.

Another innovative aspect of the subject matter described in this disclosure can be implemented in a wireless communications device for wireless communications. The wireless communications device may include a processing system that includes processor circuitry and memory circuitry that stores code. The processing system may be configured to cause the wireless communications device to communicate a beacon frame indicative of a country code associated with a 160 MHz PPDU bandwidth within a defined bandwidth, communicate, in association with the country code, frequency resource allocation information for a 100 MHz transmission within the 160 MHz PPDU bandwidth, the 100 MHz transmission including an 80 MHz subband and a 20 MHz subband, and transmit a payload of the 100 MHz transmission in accordance with the frequency resource allocation information.

Another innovative aspect of the subject matter described in this disclosure can be implemented in a wireless communications device for wireless communications. The wireless communications device may include means for communicating a beacon frame indicative of a country code associated with a 160 MHz PPDU bandwidth within a defined bandwidth, means for communicating, in association with the country code, frequency resource allocation information for a 100 MHz transmission within the 160 MHz PPDU bandwidth, the 100 MHz transmission including an 80 MHz subband and a 20 MHz subband, and means for transmitting a payload of the 100 MHz transmission in accordance with the frequency resource allocation information.

Another innovative aspect of the subject matter described in this disclosure can be implemented in non-transitory computer-readable medium storing code for wireless communications. The code may include instructions executable by one or more processors to communicate a beacon frame indicative of a country code associated with a 160 MHz physical layer PPDU bandwidth within a defined bandwidth, communicate, in association with the country code, frequency resource allocation information for a 100 MHz transmission within the 160 MHz PPDU bandwidth, the 100 MHz transmission including an 80 MHz subband and a 20 MHz subband, and transmit a payload of the 100 MHz transmission in accordance with the frequency resource allocation information.

In some examples of the method, wireless communications devices, and non-transitory computer-readable medium described herein, communicating the frequency resource allocation information may include operations, features, means, or instructions for transmitting the frequency resource allocation information in a preamble of the 100 MHz transmission.

In some examples of the method, wireless communications devices, and non-transitory computer-readable medium described herein, the 80 MHz subband may be a lower frequency band than the 20 MHz subband and a primary 20 MHz channel of the 100 MHz transmission may be located within the 80 MHz subband.

In some examples of the method, wireless communications devices, and non-transitory computer-readable medium described herein, the 80 MHz subband may be a lower frequency band than the 20 MHz subband and a primary 20 MHz channel of the 100 MHz transmission may be the 20 MHz subband.

In some examples of the method, wireless communications devices, and non-transitory computer-readable medium described herein, a (996)+(242) tone multiple resource unit (MRU) for the 100 MHz transmission, a (484+242)+(242) tone MRU for the 100 MHz transmission, or a (484)+(242) tone MRU for the 100 MHz transmission.

In some examples of the method, wireless communications devices, and non-transitory computer-readable medium described herein, communicating the frequency resource allocation information may include operations, features, means, or instructions for receiving a trigger frame including the frequency resource allocation information.

Some examples of the method, wireless communications devices, and non-transitory computer-readable medium described herein may further include operations, features, means, or instructions for transmitting, to a second wireless communications device, a message including at least one of: a field indicative of a capability of the wireless communications device to support both 100 MHz transmission and 100 MHz reception, a field indicative of a capability of the wireless communications device to support 100 MHz transmission, or a field indicative of a capability of the wireless communications device to support 100 MHz reception, and where communication of the frequency resource allocation information may be in association with the message.

Some examples of the method, wireless communications devices, and non-transitory computer-readable medium described herein may further include operations, features, means, or instructions for receiving, from the second wireless communications device, a second message including at least one of: a field indicative of a capability of the second wireless communications device to support both 100 MHz transmission and 100 MHz reception, a field indicative of a capability of the second wireless communications device to support 100 MHz transmission, or a field indicative of a capability of the second wireless communications device to support 100 MHz reception, and where communication of the frequency resource allocation information may be in association with the second message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a channelization diagram that supports 100 MHz transmission.

FIG. 6 shows an example of a process flow that supports 100 MHz transmission.

FIG. 7 shows an example of a segment parser parameters table that supports 100 MHz transmission.

FIG. 8 shows an example of a segment parser parameters table that supports 100 MHz transmission.

FIG. 9 shows a block diagram of an example wireless communication device that supports 100 MHz transmission.

FIG. 10 shows a flowchart illustrating an example process performable by or at a wireless communications device that supports 100 MHz transmission.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless communications devices such as wireless stations (STAs) and wireless access points (APs) may transmit and receive wireless communications to and from one another in the form of physical layer (PHY) protocol data units (PPDUs). Some frequency bands may be fully available in some countries, partially available in other countries, and unavailable in other countries. For example, the 160 MHz frequency band from 5735 MHz to 5895 MHz may be available in some countries (such as the United States and Canada), and entirely unavailable in other countries (such as Japan). This 160 MHz band may be only partially available in some countries, such as the 5735 MHz to 5835 MHz band is available in United Kingdom, European Union, Republic of Korea, and China. In the 5735 MHz to 5895 MHz band, 20 MHz PPDUs may be transmitted in the 20 MHz channels #149, #153, #157, #161, and #165, as defined in 802.11 specification and later amendments. 40 MHz PPDUs may be transmitted in the 40 MHz channels #151 and #149, as defined in 802.11 specification and later amendments. 80 MHz PPDUs may be transmitted in the 80 MHz channel #155, as defined in 802.11 specification and later amendments. But no PPDUs with greater than 80 MHz bandwidth may be used in this frequency band in some countries, such as United Kingdom, European Union, Republic of Korea, and China. In the United States, a 160 MHz channel #163 corresponds to the 5735 MHz to 5895 MHz band. However, in the United States, channel #163 extends into Federal Communications Commission (FCC) unlicensed national information infrastructure (UNII)-4 band which is designated for indoor transmission only (for example, outdoor transmission may have different power limitations than indoor transmissions). While 160 MHz PPDUs may be transmitted in the 160 MHz channel #163 in indoor environment in United States and Canda, transmissions of greater than 80 MHz, such as 100 MHz, may be considered in this frequency band. An AP may indicate a country code in which the AP is located in a beacon frame, which may indicate whether transmission in the 5735 MHz to 5835 MHz band is available.

Various aspects relate generally to a 100 MHz transmission in a defined bandwidth in which a 160 MHz PPDU is supported. For example, based on the country code in a beacon frame indicating a country in which a 160 MHz PPDU is supported within a defined bandwidth, wireless communications devices may communicate 100 MHz transmissions within the defined bandwidth. For example, the 100 MHz transmission may be within the lower 100 MHz band of the 160 MHz defined bandwidth, where the highest 60 MHz band may be not in use. In various aspects, the 100 MHz transmission may include an 80 MHz subband in the lower 80 MHz subband of the 160 MHz PPDU bandwidth and a 20 MHz subband in the upper 80 MHz subband of the 160 MHz PPDU bandwidth. In some aspects, the defined bandwidth of 160 MHz may be the 5735 MHz to 5895 MHz band. For example, the 160 MHz channel #163 may be split into an 80 MHz subchannel (such as between 5735 MHz and 5815 MHz) and a 20 MHz subchannel (such as between 5815 MHz and 5835 MHz). Puncturing patterns may be defined within the 100 MHz transmission. For example, one or more 20 MHz subbands within the 100 MHz transmission may be punctured. Thus, a 100 MHz transmission within a 160 MHz PPDU may refer to a transmission in which the highest 60 MHz band of the 160 MHz PPDU may be not in use and the transmission occurs in the lower 100 MHz of the of the 160 MHz PPDU (including if parts of the lower 100 MHz PPDU are punctured).

Particular aspects of the subject matter described in this disclosure can be implemented to realize one or more of the following potential advantages. In some examples, by using 100 MHz transmissions, the described techniques can be used to increase bandwidth of transmissions within a defined bandwidth as compared to 80 MHz PPDUs, 40 MHz PPDUs, or 20 MHz PPDUs. By increasing the bandwidth of a transmission, the achievable throughput of the transmission may be increased. Additionally, or alternatively, by designing a 100 MHz transmission as 80 MHz subchannel and a 20 MHz subchannel, existing 80 MHz and 20 MHz resource unit(s) (RUs) may be used for scheduling a 100 MHz transmission in the defined bandwidth. Additionally, or alternatively, in cases where the defined bandwidth is the 5735 MHz to 5895 MHz band, the 100 MHz transmission may be between 5735 MHz and 5835 MHz, and accordingly may be transmitted in the FCC UNII-3 band designated for both indoor and outdoor transmissions. Accordingly, the same transmission power and/or power spectral density requirements associated with the FCC UNII-3 band may be applied across the 100 MHz transmission. As FCC UNII-4 may have stricter power spectral density requirements than FC UNII-3, 100 MHz transmissions within the FCC UNII-3 band my use higher power and therefore be received with higher accuracy.

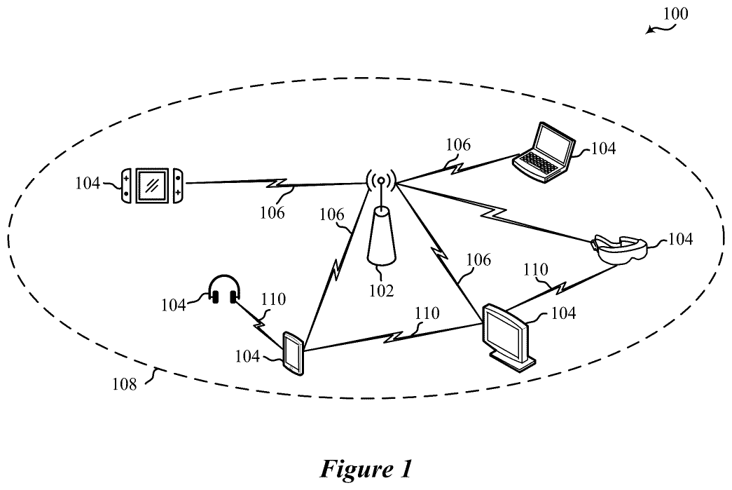

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the PHY and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHZ-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

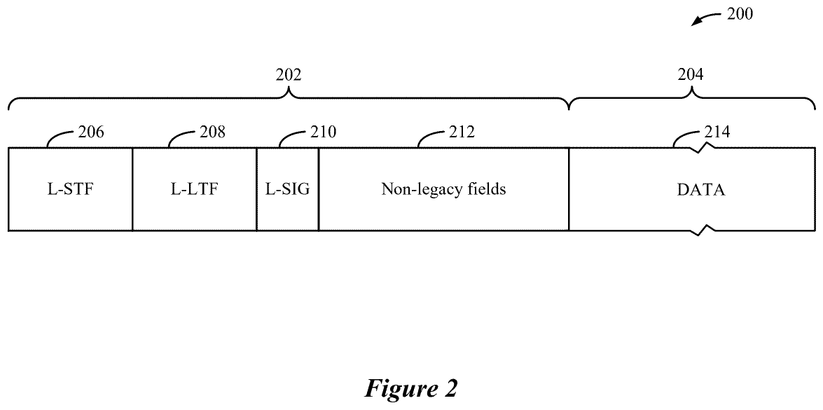

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

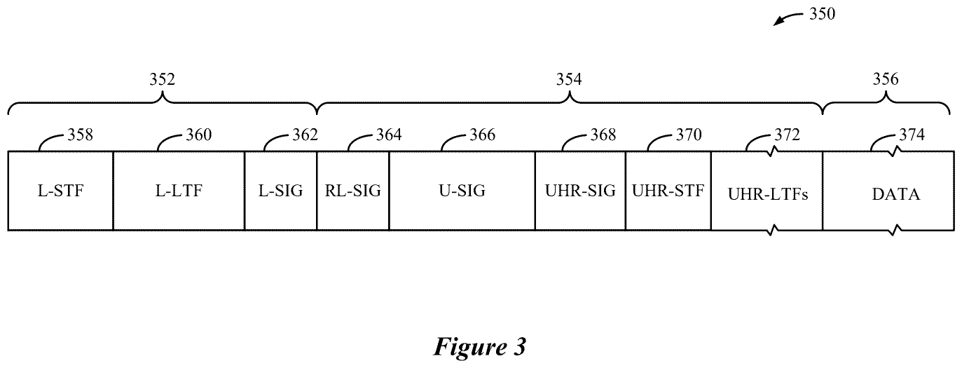

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

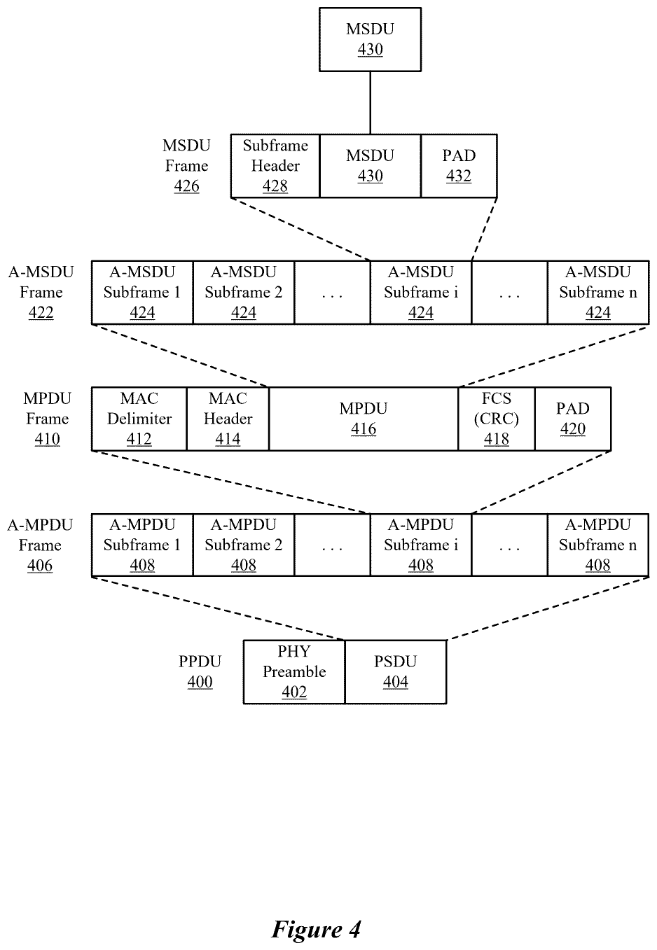

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

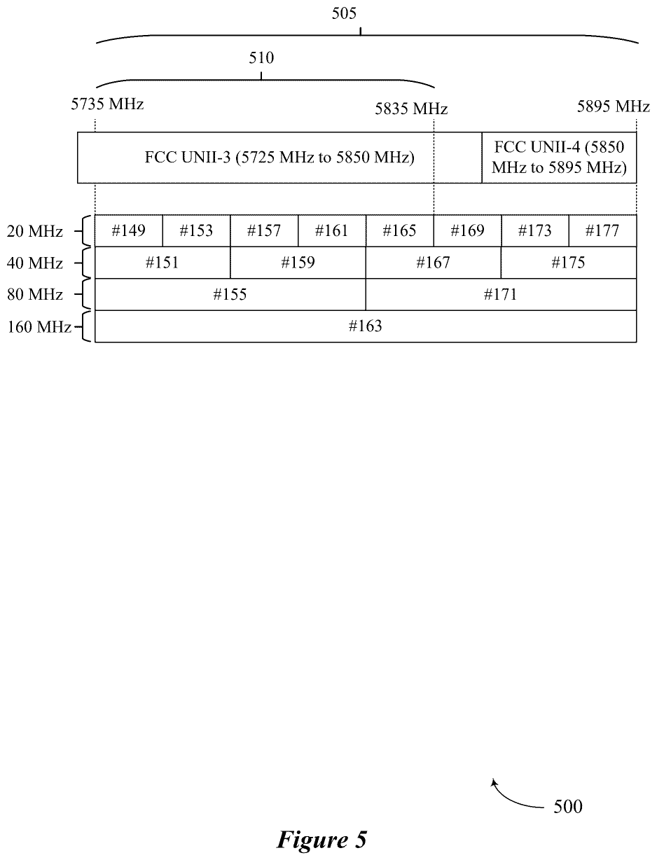

FIG. 5 shows an example of a channelization diagram 500 that supports 100 MHz transmission. The channelization diagrams 500 may implement or may be implemented by aspects of the wireless communication network 100.

As described herein, within the 5735 MHz-5895 MHz band 505, wireless communications devices such as STAs 104 and APs 102 may use 80 MHz PPDU bandwidths. In some examples, as described herein, within the 5735 MHz-5895 MHz band 505 wireless communications devices such as STAs 104 and APs 102 may use 100 MHz transmissions.

The 5735 MHz-5895 MHz band 505 may include the 20 MHz channels #149, #153, #157, #161, #165, #169, #173, #177. The 5735 MHz-5895 MHz band 505 may include the 40 MHz channels #151, #159, #167, and #171. The 5735 MHz-5895 MHz band 505 may include the 80 MHz channels #155 and #171. The 5735 MHz-5895 MHz band 505 may include the 160 MHz channel #163. The 5735 MHz-5835 MHz band 505 may be available in some countries, partially available in some countries, and unavailable in some countries. For example, the 5735 MHz to 5895 MHz band may be available the United States and Canada, the 5735 MHz to 5835 MHz may be available in the United Kingdom, the European Union, the Republic of Korea, and China, and the 5735 MHz to 5895 MHz band 505 may be entirely unavailable in Japan.

As shown in FIG. 5, FCC UNII-3 may extend between 5725 MHz and 5850 MHz, and FCC UNII-4 may extend between 5850 MHz and 5895 MHz. Accordingly, the 5735 MHz-5895 MHz band 505 may include FCC UNII-3 and FCC UNII-4. Transmissions in FCC UNII-3 and FCC UNII-4 may have different power and/or power spectral density requirements, as shown in Table 1 (AP requirements) and Table 2 (client/STA requirements). For example, FCC UNII-3 may be designated for both indoor and outdoor transmissions and FCC UNII-4 may be designate for indoor transmissions only. Thus, in the United States, a 160 MHz transmission in the 5735 MHz-5895 MHz band 505 may be indoor only (for example, may comply with the FCC UNII-4 requirements).

TABLE 1

| | AP | | | |
|---|---|---|---|---|
| | Array Gain | | | |
| | allowance | | | |
| | (applies to | Total limit | PSD limit | PSD RBW |
| Name | Total & PSD) | (dBm) | (dBm) EIRP | (kHz) |
| UNII-3 | 6 | 30 | 30 | 500 |
| UNII-4 | 0 | 36 | 20 | 1000 |

TABLE 2

| | Client | | | |
|---|---|---|---|---|
| | Array Gain | | | |
| | allowance | | | |
| | (applies to | Total limit | PSD limit | PSD RBW |
| Name | Total & PSD) | (dBm) | (dBm) EIRP | (kHz) |
| UNII-3 | 6 | 30 | 30 | 500 |
| UNII-4 | 0 | 30 | 14 | 1000 |

In some examples, as described herein, a 100 MHz transmission within the 5735 MHz-5895 MHz band 505 may be within the lower 100 MHz of the 5735 MHz-5895 MHz band 505 (such as within the allowed band for the United Kingdom, the European Union, the Republic of Korea, and China) and within FCC UNII-3. The lower 100 MHz of the 5735 MHz-5895 MHz band 505 may be referred to as the 5735 MHz-5835 MHz band 510. In some examples (referred to as Option 1), a 100 MHz transmission within the 5735 MHz-5835 MHz band 510 may reuse a 160 MHz PPDU bandwidth mode. In such examples, the baseband direct current (DC) location may split the 100 MHz transmission into an 80 MHz lower subband and a 20 MHz higher subband. For example, the 80 MHz subband may include a first 484-tone RU (for example, at the lower 40 MHz within the 80 MHz subband) and a second 484-tone RU (for example, at the higher 40 MHz within the 80 MHz subband) in the 80 MHz subband and a 242-tone RU in the 20 MHz subband (for example, adjacent to the 80 MHz subband in the frequency domain) with the DC location between the second 484-tone RU and the 242-tone RU. In some examples (referred to as Option 2), a 100 MHz transmission within the 5735 MHz-5835 MHz band 510 may define a new 100 MHz PPDU bandwidth mode. In a 100 MHz PPDU bandwidth mode, the baseband DC location may split the 100 MHz transmission into a 40 MHz lower subband and a 60 MHz higher subband. For example, the 40 MHz subband may include a first 484-tone RU (for example, at the lower 40 MHz within the 100 MHz PPDU bandwidth) and a second 484-tone (for example, at the lower 40 MHz within the 60 MHz subband) and a 242-tone RU (for example, at the higher 20 MHz within the 60 MHz subband) in in the 60 MHz subband, with the DC location between the first 484-tone RU and the second 484-tone RU.

A 100 MHz transmission in the 5735 MHz-5835 MHz band 510 may allow puncturing. In some examples, a 100 MHz transmission in the 5735 MHz-5835 MHz band 510 may be an OFDMA transmission, in which case existing RUs or MRUs may be used (for example, (M) RUs in 80 MHz and (M) RUs in 20 MHz corresponding to Option 1). In some examples, a 100 MHz transmission in the 5735 MHz-5835 MHz band 510 may be a non-OFDMA transmission, in which case a new MRU may be defined (for example, a 996+242 tone MRU corresponding to Option 2 may be defined).

In some examples, as described with reference to Option 1, a 100 MHz transmission in the 5735 MHz-5835 MHz band 510 may reuse the 160 MHz bandwidth mode based on channelization (such as to not confuse devices in the United States and Canada). In some such examples, the DC may be located in the center of the 160 MHz channel #163, splitting the 100 MHz into 80 MHz+20 MHz (such as the 80 MHz lower subband and the 20 MHz upper subband). The 100 MHz transmission mode within the 160 MHz bandwidth mode may be allowed in the 160 MHz channel #163 and selected countries (for example, based on the country code in the beacon frame transmitted by an AP 102). Puncturing in the lower 80 MHz frequency subblock may be allowed and may ensure that two content channels are present in UHR-SIG.

In a first design for primary and secondary channels, the primary 80 MHz channel for the 100 MHz transmission may be the lower 80 MHz subband of the 160 MHz bandwidth and the primary 20 MHz channel for the 100 MHz transmission may be within the lower 80 MHz subband. Accordingly, the upper 80 MHz subband of the 160 MHz bandwidth may be the secondary 80 MHz, and for a 100 MHz transmission, only the lowest 20 MHz of the secondary 80 MHz may be used. In the first design, the primary 20 MHz channel shall not be the lowest 20 MHz of the upper 80 MHz subband of the 160 MHz bandwidth. In the first design, non-primary channel access (NPCA) and dynamic sub-channel operation (DSO) in the secondary 80 MHz subband for the 100 MHz transmission may be located in the lowest 20 MHz in the secondary 80 MHz subband. In the first design, intended STAs 104 (such as target STAs 104 connected to the AP 102 s) may park in the primary 80 MHz channel to process the PHY preamble. An MU PPDU preamble in the secondary 80 MHz may be used by bystander devices (such as to determine the channel is busy or occupied). Absent a new design, the preamble of a high efficiency (HE) MU PPDU, an extremely high efficiency (EHT) MU PPDU or a UHR MU PPDU in the secondary 80 MHz may not be able to indicate the 20 MHz channel within the secondary 80 MHz as a 60 MHz puncturing pattern may not be defined. In some examples, the Bandwidth Field in the HE-SIG-A in an HE MU PPDU does not have a state to indicate a puncturing pattern where more than two adjacent 20 MHz subchannels are punctured in one 80 MHz frequency subblock with a 160 MHz PPDU. Even in this case, in some examples, in an HE MU PPDU with OFDMA transmission, the Bandwidth Field in the HE-SIG-A may still be set to indicate 160 MHz without puncturing or one of the two allowed punctured patterns associated with 160 MHz as defined in the 802.11ax specification, according to the punctured pattern in the lower 80 MHz which is the primary 80 MHz. In some examples, the Punctured Channel Info Field in the U-SIG in an EHT MU PPDU or a UHR MU PPDU may be set to a disallowed puncturing pattern (which may be a Validate state) in the secondary 80 MHz to trigger termination of receiver processing of the preamble in the secondary 80 MHz. In some examples, only one content channel of UHR-SIG may be present in the secondary 80 MHz. In some examples, in an EHT MU PPDU with OFDMA transmission or a UHR MU PPDU with OFDMA transmission, the Punctured Channel Info Field in the U-SIG in the primary 80 MHz may be a defined and valid puncturing pattern, but the Punctured Channel Info Field in the U-SIG in the secondary 80 MHz may be set to a disallowed punctured pattern (which may be a Validate state). In the first design, as long as the intended devices only process the preamble in primary 80 MHz, with two content channels available in HE-SIG-B, EHT-SIG or UHR-SIG, respectively, the intended devices may be able to receive an HE MU PPDU with OFDMA transmission, an EHT MU PPDU with OFDMA transmission or a UHR MU PPDU properly. In the first design, a 100 MHz transmission may use a non-HT duplication PPDU (non-HT Dup PPDU), where the bandwidth indication in the Service Field may indicate 160 MHz. The receiver may rely on packet detection, bandwidth detection and punctured channel detection to properly perform frequency combining of the non-HT Dup PPDU over non-punctured 20 MHz subchannels.

In a second design for primary and secondary channels, the primary 20 MHz channel may be any 20 MHz subband within the lower 80 MHz subband or the lowest 20 MHz in the upper 80 MHz subband. For example, the lowest 20 MHz in the upper 80 MHz may be less occupied, which may result in less backoff in transmission opportunity competition because random backoff may be based on the primary 20 MHz, but not the entire bandwidth. In the second design, NPCA and DSO in the secondary 80 MHz subband for the 100 MHz transmission may be located in the lower 80 MHz, i.e., the secondary 80 MHz subband. A 100 MHz transmission may not be transmitted using an HE PPDU or EHT PPDU in this case due to an invalid puncturing pattern in the primary 80 MHz. A UHR MU PPDU preamble may involve several changes to enable the lowest 20 MHz in the upper 80 MHz to be the primary 20 MHz. In the second design, a 100 MHz transmission may use a non-HT duplication PPDU (non-HT Dup PPDU), where the bandwidth indication in the Service Field may indicate 160 MHz. The receiver may rely on packet detection, bandwidth detection and punctured channel detection to properly perform frequency combining of the non-HT Dup PPDU over non-punctured 20 MHz subchannels.

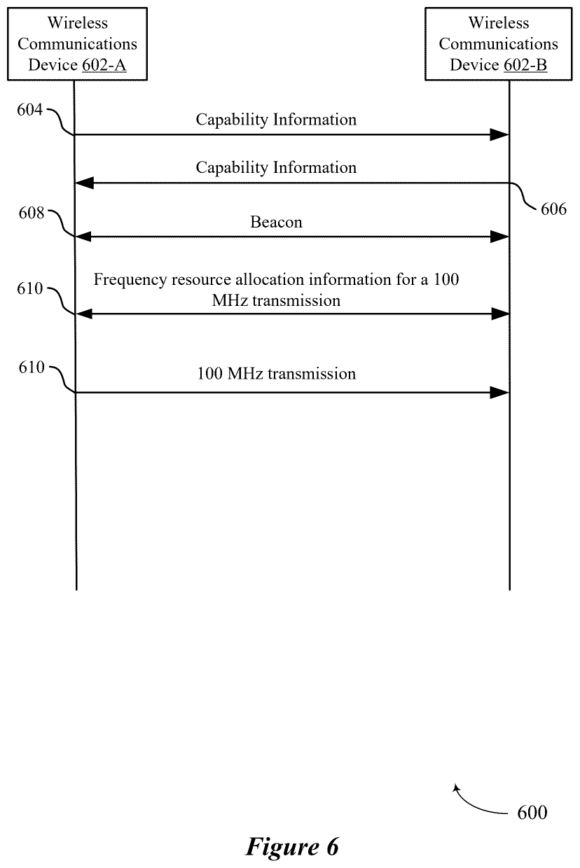

FIG. 6 shows an example of a process flow 600 that supports 100 MHz transmission. The process flow 600 includes a first wireless communications device 602-a and a second wireless communications device 602-b, which may be examples of APs 102 or STAs 104 as described herein. In the following description of the process flow 600, the operations between the first wireless communications device 602-a and the second wireless communications device 602-b may be transmitted in a different order than the example order shown, or the operations performed by the first wireless communications device 602-a and the second wireless communications device 602-b may be performed in different orders or at different times. Some operations also may be omitted from the process flow 600, and other operations may be added to the process flow 600.

As described herein, the first wireless communications device 602-a and the second wireless communications device 602-b may support communication of a 100 MHz transmission in a defined bandwidth in which a PPDU bandwidth of at least 100 MHz is supported (for example, a 160 MHz PPDU bandwidth). For example, at 608, the first wireless communications device 602-a and the second wireless communications device 602-b may communicate a beacon frame indicative of a country code. The country code may indicate support of a PPDU bandwidth (for example, a 160 MHz PPDU bandwidth) within the defined bandwidth and/or support of at least a portion of the defined bandwidth. For example, the first wireless communications device 602-a may be an AP 102 which transmits the beacon, or the first wireless communications device 602-a may be an client device such as a STA 104 which receives the beacon. In some examples, the defined bandwidth may be the 5735 MHz to 5895 MHz band.

At 610, the first wireless communications device 602-a and the second wireless communications device 602-b may communicate, in association with the country code, frequency resource allocation information for a 100 MHz transmission within the 160 MHz PPDU bandwidth. The 100 MHz transmission may include an 80 MHz subband and a 20 MHz subband. For example, for an uplink trigger based (TB) transmission, the second wireless communications device 602-b may be an AP 102 and may transmit a trigger frame that includes the frequency resource allocation information at 610. As another example, for a downlink transmission or a point-to-point transmission, the first wireless communications device 602-a may be an AP 102 and may transmit the frequency resource allocation information for the 100 MHz transmission in the preamble of the 100 MHz transmission.

At 612, the first wireless communications device 602-a may transmit, and the second wireless communications device 602-b may receive, a payload of the 100 MHz transmission in accordance with the frequency resource allocation information.

In some examples, the 100 MHz transmission may be an MU PPDU with OFDMA transmission. Where the 100 MHz transmission is an MU PPDU with OFDMA transmission, existing (M) RUs in the lower 80 MHz subband and (M) RUs in the lowest 20 MHz subband in the higher 80 MHz subband may be used (for example, there may not be a demand to define new (M) RU sizes). No (M) RUs in the upper 60 MHz subband in the higher 80 MHz subband may be assigned to users. In an HE MU PPDU with OFDMA transmission, the RU allocation subfields corresponding to the upper 60 MHz subband in the higher 80 MHz subband may be set to ‘242-tone RU empty (with zero user)’ or ‘484-tone RU empty (with zero user)’, as defined in the 802.11ax specification. In an EHT MU PPDU with OFDMA transmission or a UHR MU PPDU with OFDMA transmission, the RU allocation subfields corresponding to the upper 60 MHz subband in the higher 80 MHz subband may be set to ‘punctured 242-tone RU’ or ‘unassigned 242-tone RU’. The highest 80 MHz may have a punctured pattern of [1 x x x] (for example, where 1 indicates not punctured and “x” indicates punctured for the 20 MHz subbands of the 80 MHz subband, thus [1 x x x] indicates the lowest 20 MHz of the highest 80 MHz subband is not punctured and the remaining 20 MHz subbands of the of the highest 80 MHz subband are punctured). The MU PPDU with OFDMA transmission may typically have two content channels in UHR-SIG and may use a [1 2 1 2] content channel structure in each 80 MHz subband (for example, where [1 2 1 2] indicates that the same content/data “1” is transmitted on the first and third 20 MHz subbands of the 80 MHz subband and that the same content/data “2” is transmitted on the second and fourth 20 MHz subbands of the 80 MHz subband).

The highest 80 MHz subband may have only one content channel (for example, due to having a single 20 MHz subband being used) for a 100 MHz transmission, however. If the primary 20 MHz is always within the lower 80 MHz and all STAs parked in the primary 80 MHz subband, the preamble in lower 80 MHz may be processed by the STAs parked in the primary 80 MHz subband. The preamble in highest 80 MHz subband may be used by bystander devices which may terminate receiver processing at U-SIG. A single content channel in UHR-SIG in the secondary 80 MHz subband accordingly may be determined by the intended STAs 104 (for example, such as the second wireless communications device 602-b) in association with the country code, frequency resource allocation information for a 100 MHz transmission within the 160 MHz PPDU bandwidth, or based on additional signaling indication. The UHR-SIG in the lowest 20 MHz in the highest 80 MHz subband may carry information of one content channel or dummy information.

If the primary 20 MHz is within the lower 80 MHz and all STAs parked in the primary 80 MHz subband, a 100 MHz OFDMA transmission may use an EHT MU PPDU with downlink OFDMA transmission or a UHR MU PPDU with downlink OFDMA transmission. If the primary 20 MHz subband is the lowest 20 MHz in the higher (for example, highest as there are two 80 MHz subbands) 80 MHz subband, a 100 MHz OFDMA transmission may not use an EHT MU PPDU and may use a UHR MU PPDU with downlink OFDMA transmission with some modifications.

If the primary 20 MHz subband is allowed to be the lowest 20 MHz in the higher (for example, highest as there are two 80 MHz subbands) 80 MHz subband, a punctured pattern of [1 x x x] may be indicated to STAs 104, for example, according to one of the following options. In a first option (suboption A), intended STAs 104 may be required to process UHR-SIG in the lower 80 MHz subband (which is the secondary 80 MHz). Suboption A may demand the STAs 104 to be able to process a 160 MHz preamble (for example, the UHR-SIG in the 160 MHz preamble). In some examples, the punctured channel info field may be modified to also indicate the punctured pattern or the location of the content channels in the lower 80 MHz subband. For example, even though the 100 MHz transmission may be a OFDMA transmission, the punctured channel info field may use all 5 bits in the punctured channel info field and be interpreted as if in a non-OFDMA transmission with new punctured patterns. For example, values 13-19 in the Punctured Channel Information Subfield may be used to indicate the punctured pattern of [1 1 1 1 1 x x x] (using value 13 to indicate total 100 MHz), four punctured patterns [x 1 1 1 1 x x x], [1×1 1 1 xxx], [1 1 x 1 1 xxx] and [1 1 1×1 x x x] (using values 14-17 to indicate puncturing of a 20 MHz subband in the lower 80 MHz subband within the total 100 MHz), and two punctured patterns [x x 1 1 1 x x x] and [1 1 x x 1 x x x] (using values 18-19 to indicate puncturing of a 40 MHz subband in the lower 80 MHz subband within the total 100 MHz). As used herein, “1” represents an unpunctured 20 MHz subband and “x” represents a punctured 20 MHz subband. As another example, the location of another content channel may be indicated for the intended STAs to find two distant content channels for continued preamble processing. Currently 4 out of 5 bits in the Punctured Channel Info Field may be used to indicate the punctured pattern (in a 4-bit bitmap with 20 MHz granularity) of an 80 MHz subband with the most significant bit (MSB) set to 1 and treated as “Disregard.” Given there is a content channel available in the higher 80 MHz subband, the STAs 104 may be informed of the availability of the available content channel. The MSB of the Punctured Channel Info Field may be used to indicate if the other content channel is available in the second lowest 20 MHz subband (value 0) or highest 20 MHz subband (value 1) in the lower 80 MHz subband. The MSB may be set to either value if both the second lowest 20 MHz subband and highest 20 MHz subband in the lower 80 MHz subband are available. As another example, the 4 disregard bits in U-SIG may be used to indicate the punctured channel info for the lower 80 MHz (for example, the same way of a 4-bit bitmap with 20 MHz granularity). As another example, the intended STAs 104 may have a capability to process the 160 MHz preamble (from L-STF) and detect bandwidth and punctured channels. In a second option (suboption B), the UHR-SIG may be changed to use a single content channel structure, where all RU allocation subfields and all user fields may be carried in one content channel. Suboption B may not demand the STAs 104 to be able to process a 160 MHz preamble (for example, the UHR-SIG in the 160 MHz preamble).

Accordingly, in some examples, the 100 MHz transmission may be a non-OFDMA transmission, where a preamble of the 100 MHz transmission indicates a punctured channel configuration of an entirety of the 160 MHz PPDU bandwidth; or the preamble indicates a punctured and unpunctured channel configuration of an entirety of the 80 MHz subband or a subset of 20 MHz subchannels of the entirety of the 80 MHz subband. A 100 MHz non-OFDMA transmission may not use an HE MU PPDU or an EHT MU PPDU with downlink non-OFDMA transmission. A 100 MHz single user transmission or non-OFDMA transmission may use a UHR MU PPDU with single user transmission or downlink non-OFDMA transmission with some modifications. A 100 MHz OFDMA transmission may use a UHR MU PPDU with downlink OFDMA transmission with some modifications.

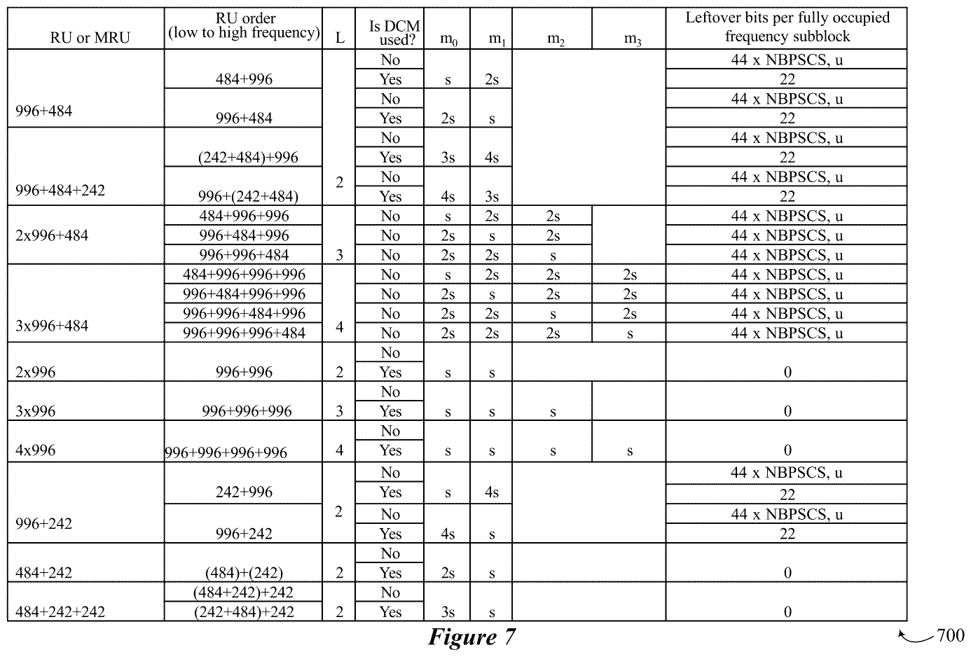

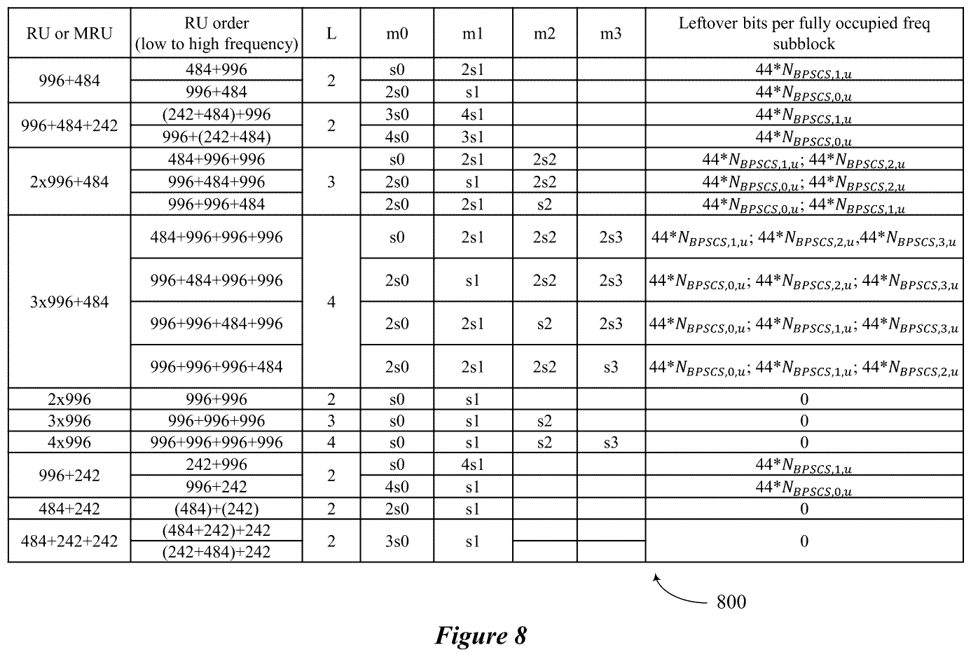

In some examples, the 100 MHz transmission may be an MU PPDU with non-OFDMA transmission. A 100 MHz transmission non-OFDMA transmission may involve new MRU sizes and segment parsers (for example, as described with respect to FIGS. 7 and 8). New punctured patterns may be defined where 60 MHz is punctured in the higher 80 MHz subband (for example, where the punctured patterns may currently be in “Validate” states that trigger the receiver to terminate processing). In the case of non-OFDMA SU transmission, the PPDU with SU transmission may have a single content channel in the UHR-SIG and uses a [1 1 1 1] content channel structure in each 80 MHz subband, and accordingly there may be no issue when there is only one content channel in the higher 80 MHz subband (for example, no issue for an intended STA 104 to process the UHR-SIG). In the case of non-OFDMA MU-MIMO transmission, the MU PPDU with non-OFDMA MU-MIMO transmission may include two content channels in UHR-SIG and uses a [1 2 1 2] content channel structure in each 80 MHz subband. However, for a 100 MHz transmission, the higher 80 MHz subband may have one content channel due to having a single 20 MHz subband within the higher 80 MHz subband available. If the primary 20 MHz subband is always within the lower 80 MHz subband and all intended STAs 104 are parked in the primary 80 MHz subband, the preamble in lower 80 MHz subband may be processed by the intended STAs 104 (for example, including the second wireless communications device 602-b). The preamble the higher 80 MHz subband may be used by bystander devices which may terminate receiver processing at U-SIG. A single content channel in UHR-SIG in the secondary 80 MHz subband may be determined by the intended STAs 104 (for example, such as the second wireless communications device 602-b). The UHR-SIG in the lowest 20 MHz subband in the higher 80 MHz subband may carry information of one content channel or dummy information. If the primary 20 MHz is allowed to be the lowest 20 MHz in the higher 80 MHz subband, in a first option (suboption A) intended STAs 104 (for example, including the second wireless communications device 602-b) may be required to process UHR-SIG in the lower 80 MHz subband. Suboption A may demand the STAs 104 to be able to process a 160 MHz preamble (for example, the UHR-SIG in the 160 MHz preamble). In suboption A, the available content channels may be determined by the intended STAs 104 based on the Punctured Channel Info Field. If the primary 20 MHz is allowed to be the lowest 20 MHz in the higher 80 MHz subband, in a second option (suboption B), the UHR-SIG may use a single content channel structure, where all user fields are carried in one content channel. Suboption B may not demand the STAs 104 to be able to process a 160 MHz preamble (for example, the UHR-SIG in the 160 MHz preamble).

Thus, in some examples, where the 100 MHz transmission is a downlink transmission the 100 MHz transmission may be either an OFDMA transmission or a non-OFDMA MU MIMO transmission, and a subsequent signal field after a universal signal field in a preamble of the 100 MHz transmission may use a single content channel structure for the 100 MHz transmission.

In some examples, the frequency resource allocation information may be transmitted by the second wireless communications device 602-b in a trigger frame, and the 100 MHz transmission at 612 may be a trigger based (TB) PPDU. The trigger frame may solicit a trigger based PPDU, which may indicate a 160 MHz PPDU. User(s) may be assigned (M) RUs with self contained user information fields in a trigger frame. Only the (M) RUs within the 100 MHz frequency band (i.e., the lower 80 MHz subband and the lowest 20 MHz subband in the upper 80 MHz subband) may be assigned to user(s). The (M) RUs in the upper 60 MHz subband of the upper 80 MHz subband may not be assigned to any user. An HE TB PPDU or an EHT TB PPDU may support OFDMA transmission, but may not support non-OFDMA transmission corresponding to the 100 MHz subband. A UHR Trigger based PPDU may support OFDMA and non-OFDMA transmissions, and may support multiple (new) MRU sizes. A 100 MHz transmission in response to a trigger based PPDU may use masks to transmit the 100 MHz transmission over the defined 160 MHz bandwidth. For example, a mask for an 80 MHz+20 MHz may be defined and used, a set of masks for 60 MHz+20 MHz with 20 MHz punctured allowed in the lower 80 MHz subband may be defined and used, and/or a set of masks for 40 MHz+2 0 MHz with 40 MHz punctured in the lower 80 MHz subband may be defined and used. For a trigger based PPDU, the primary 20 MHz may be either within the lower 80 MHz subband or the higher 80 MHz subband.

As described herein, new MRUs may be used for a 100 MHz OFDMA or non-OFDMA transmission. As used herein, “( )” may be used to indicate the (M) RU size within each 80 MHz subband if the RU size is not 996. In some examples, a new MRU, 996+242, may be defined as highest 60 MHz punctured in the defined 160 MHz band. In such examples, the punctured pattern of [1 1 1 1 1 x x x] may be added to the Punctured Channel Information Subfield (using value 13). As used herein, “1” represents an unpunctured 20 MHz subband and “x” represents a punctured 20 MHz subband. In some examples, a new MRUs with 20 MHz or 40 MHz punctured in the lower 80 MHz subband may be defined, in addition to the highest 60 MHz being punctured in the defined 160 MHz band. For example, to puncture 20 MHz in the lower 80 MHz subband, an MRU (484+242)+242 may be defined. Depending on which 20 MHz subband in the lower 80 MHz subband is punctured, there are four MRUs (484+242) in the lower 80 MHz subband to form the new MRU size. Thus, the corresponding punctured patterns [x 1 1 1 1 x x x], [1×1 1 1 xxx], [1 1 x 1 1 xxx], [1 1 1 x 1 x x] may be added to the Punctured Channel Information Subfield (using values 14-17). As another example, to puncture 40 MHz in the lower 80 MHz subband, an MRU (484)+(242) may be defined. Depending on which 40 MHz subband in the lower 80 MHz subband is punctured, there are two RUs 484 in the lower 80 MHz subband to form the new MRU size. Thus, the corresponding punctured patterns [x x 1 1 1 x x x], [1 1 x x 1 x x x] may be added to the Punctured Channel Information Subfield (using values 18-19).

Accordingly, the frequency resource allocation information at 610 may include a punctured channel information field, and the punctured channel information field may indicate at least one of: a [1 1 1 1 1 x x x] puncturing pattern associated with a (996)+(242) tone multiple resource unit; a [x 1 1 1 1 x x x], [1×1 1 1 x x x], [1 1 x 1 1 x x x], or [1 1 1×1 xxx] puncturing pattern associated with a (484+242)+(242) tone multiple resource unit; or a [x x 1 1 1 x x x] or [1 1 x x 1 x x x] puncturing pattern associated with a (484)+(242) tone multiple resource unit.

As shown with reference to FIGS. 7 and 8, a first segment parser operation may be associated with the (996)+(242) tone multiple resource unit, a second segment parser operation may be associated with the (484+242)+(242) tone multiple resource unit, and a third segment parser operation may be associated with the (484)+(242) tone multiple resource unit.

In some examples, the 100 MHz transmission may be a frequency domain (FD) aggregated (A) PPDU. In an FD-A-PPDU, puncturing may be allowed in the lower 80 MHz subband. NPCA or DSO may be used to move UHT STAs to the secondary channel to enable FD-A-PPDU. In some examples, the first wireless communications device 602-a and the second wireless communications device 602-b may support the same generation FD-A-PPDU, where all sub-PPDUs in an FD-A-PPDU use the PPDU format of the same WiFi generation. For example, the 100 MHz transmission may be an HE80+HE20 transmission, which may be an HE 80 MHz SU PPDU+HE 80 MHz SU PPDU (for example, in the downlink direction or point-to-point) or an HE 80 MHz TB PPDU+HE 80 MHz TB PPDU (for example, in the uplink direction). As another example, the 100 MHz transmission may be an EHT80+ EHT 20 transmission, which may be an EHT 80 MHz MU PPDU+ EHT 80 MHz MU PPDU (for example, in the downlink direction or point-to-point) or an EHT 80 MHz TB PPDU+ EHT 80 MHz TB PPDU (for example, in the uplink direction). As another example, the 100 MHz transmission may be a UHR80+ UHR 20 transmission, which may be a UHR 80 MHz MU PPDU+ UHR 80 MHz MU PPDU (for example, in the downlink direction or point-to-point) or a UHR 80 MHz TB PPDU+ UHR 80 MHz TB PPDU (for example, in the uplink direction).

In some examples, the first wireless communications device 602-a and the second wireless communications device 602-b may support multiple generation FD-A-PPDU, where not all sub-PPDUs in an FD-A-PPDU use the PPDU format of the same WiFi generation, such as an EHT+ UHR FD-A-PPDU. For example, the 100 MHz transmission may be an EHT80+ UHR20 transmission if the primary 80 MHz subband is the lower 80 MHz, which may be an EHT 80 MHz MU PPDU+ UHR 20 MHz MU PPDU (for example, in the downlink direction or point-to-point) or an EHT 80 MHz TB PPDU+ UHR 20 MHz TB PPDU (for example, in the uplink direction). As another example, the 100 MHz transmission may be a UHR80+ EHT20 transmission if the primary 20 MHz subband is in the lowest 20 MHz of the upper 80 MHz, which may be a UHR 80 MHz MU PPDU+ EHT 20 MHz MU PPDU (for example, in the downlink direction or point-to-point) or a UHR 80 MHz TB PPDU+ EHT 20 MHz TB PPDU (for example, in the uplink direction).

In some examples, the first wireless communications device 602-a and the second wireless communications device 602-b may exchange capability signaling to indicate whether the first wireless communications device 602-a and the second wireless communications device 602-b support 100 MHz transmission within the defined bandwidth. For example, whether the 100 MHz transmission design defines a new PPDU bandwidth or is based on the 160 MHz PPDU, 100 MHz transmission may be optional and support of the optional 100 MHz transmission may be signaled in a capability exchange. For example, at 604 the first wireless communications device 602-a may transmit a first message that includes: a field indicative of a capability of the wireless communications device to support both 100 MHz transmission and 100 MHz reception, a field indicative of a capability of the wireless communications device to support 100 MHz transmission, or a field indicative of a capability of the wireless communications device to support 100 MHz reception. At 606, the first wireless communications device 602-a may transmit a second message that includes: a field indicative of a capability of the second wireless communications device to support both 100 MHz transmission and 100 MHz reception, a field indicative of a capability of the second wireless communications device to support 100 MHz transmission, or a field indicative of a capability of the second wireless communications device to support 100 MHz reception. Transmission of the frequency resource allocation information at 608 may be based on the first and/or second message.

In some examples, the field indicating the capability (for example, in the first or second message) may be a single-bit capability element field that jointly indicates support for transmission and reception of the 100 MHz transmission. The single-bit field may be set to “1” to indicate support for transmission and reception of 100 MHz transmissions, and set to “0” to indicate non-support for transmission and reception of 100 MHz transmissions. In some examples, the field indicating the capability may be a 2-bit capability field, with 1-bit for transmission capability and 1-bit for reception capability for 100 MHz transmissions. The reception capability sub-field may be set to “1” to indicate support for reception of 100 MHz transmissions, and set to “0” to indicate non-support of reception of 100 MHz transmissions. The transmission capability sub-field may be set to “1” to indicate support for transmission of 100 MHz transmissions, and set to “0” to indicate non-support of The reception capability sub-field may be set to “1” to indicate support for reception of 100 MHz transmissions, and set to “0” to indicate non-support of transmission of 100 MHz transmissions. In some examples, the capability element field for indicating support of 100 MHz transmissions may expand to carry additional sub-feature signaling. For example, there are optional sub-features or modes within the overall 100 MHz PPDU transmission/reception operations, the ability to support such sub-features or modes may be indicated in the capability signaling.

FIG. 7 shows an example of a segment parser parameters table 700 that supports 100 MHz transmission. FIG. 8 show another example of a segment parser parameters table 800 that supports 100 MHz transmission. The segment parser parameters table 700 and the segment parser parameters table 800 may implement or may be implemented by aspects of the wireless communication network 100 or the process flow 600.

As described herein, new MRU sizes may be defined to support 100 MHz transmission. For example, new MRU sizes of 996+242, (484)+(242), and (484+242)+242 may be defined. Accordingly, as shown in the segment parser parameters table 700, based on adding new entries for the new MRU sizes 996+242, (484)+(242) and (484+242)+(242) to Table 36-49 (Segment parser parameters) in the 802.11be specification D7.0, new rows may be added for the new MRU sizes 996+242, (484)+(242), and (484+242)+242. Accordingly, the transmitting device of a 100 MHz transmission (for example, the first wireless communications device 602-a) may perform segment parsing operations for the 100 MHz transmission in accordance with the parameters of the relevant MRU size as indicated in the segment parser parameters table 700.

In some examples, FD unequal modulation (UEQM) may be adopted. For FD UEQM, with join coding across RUs, a QAM modulation or a set of QAM modulation for a set of spatial streams (where each QAM modulation is for one spatial stream) matched to each RU's signal to interference and noise ratio (SINR) may be selected. Accordingly, the segment parser parameters table may be updated as shown in FIG. 8 to accommodate FD UEQM, which may use the existing 802.11be segment parser with minor modifications. The segment parser parameters table 800 is based on modifying Table 36-49 (Segment parser parameters) in the 802.11be specification D7.0 for FD UEQM and may assume dual carrier modulation (DCM) is not used. New entries for the new MRU sizes 996+242, (484)+(242) and (484+242)+(242) are added to the segment parser parameters table 800.

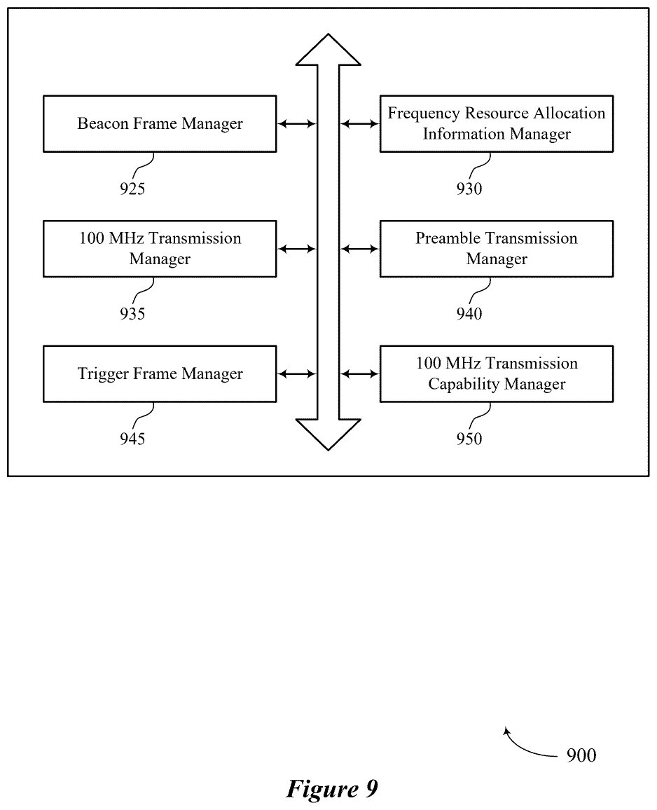

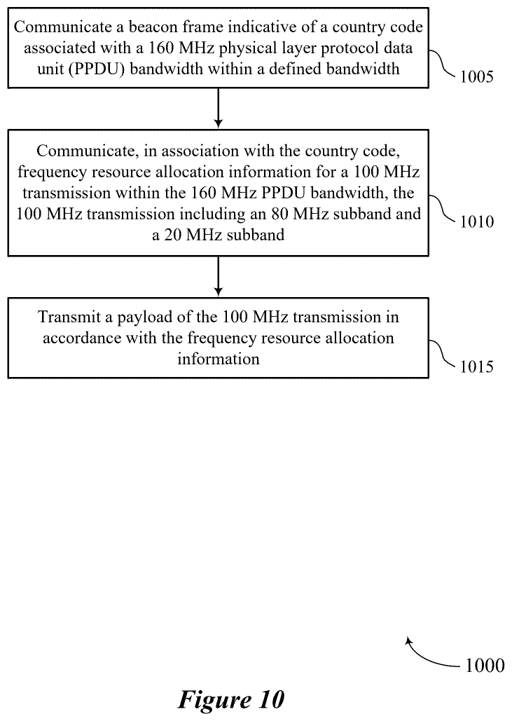

FIG. 9 shows a block diagram of an example wireless communication device 900 that supports 100 MHz transmission. In some examples, the wireless communication device 900 is configured to perform the process 1000 described with reference to FIG. 10. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in an AP or STA, such as the AP 102 or the STA 104 described with reference to FIG. 1. In some other examples, the wireless communication device 900 can be an AP or STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system. In some examples, the wireless communication device 900 further includes at least one external network interface coupled with the processing system that enables communication with a core network or backhaul network that enables the wireless communication device 900 to gain access to external networks including the Internet.

The wireless communication device 900 includes a beacon frame manager 925, a frequency resource allocation information manager 930, a 100 MHz transmission manager 935, a preamble transmission manager 940, a trigger frame manager 945, and a 100 MHz transmission capability manager 950. Portions of one or more of the beacon frame manager 925, the frequency resource allocation information manager 930, the 100 MHz transmission manager 935, the preamble transmission manager 940, the trigger frame manager 945, and the 100 MHz transmission capability manager 950 may be implemented at least in part in hardware or firmware. For example, one or more of the beacon frame manager 925, the frequency resource allocation information manager 930, the 100 MHz transmission manager 935, the preamble transmission manager 940, the trigger frame manager 945, and the 100 MHz transmission capability manager 950 may be implemented at least in part by at least a processor or a modem. In some examples, portions of one or more of the beacon frame manager 925, the frequency resource allocation information manager 930, the 100 MHz transmission manager 935, the preamble transmission manager 940, the trigger frame manager 945, and the 100 MHz transmission capability manager 950 may be implemented at least in part by a processor and software in the form of processor-executable code stored in memory.

The wireless communication device 900 may support wireless communications in accordance with examples as disclosed herein. The beacon frame manager 925 is configurable or configured to communicate a beacon frame indicative of a country code associated with a 160 MHz physical layer protocol data unit (PPDU) bandwidth within a defined bandwidth. The frequency resource allocation information manager 930 is configurable or configured to communicate, in association with the country code, frequency resource allocation information for a 100 MHz transmission within the 160 MHz PPDU bandwidth, the 100 MHz transmission including an 80 MHz subband and a 20 MHz subband. The 100 MHz transmission manager 935 is configurable or configured to transmit a payload of the 100 MHz transmission in accordance with the frequency resource allocation information.

In some examples, to support communicating the frequency resource allocation information, the preamble transmission manager 940 is configurable or configured to transmit the frequency resource allocation information in a preamble of the 100 MHz transmission.

In some examples, the 80 MHz subband is a lower frequency band than the 20 MHz subband. In some examples, a primary 20 MHz channel of the 100 MHz transmission is located within the 80 MHz subband.

In some examples, the 80 MHz subband is a lower frequency band than the 20 MHz subband. In some examples, a primary 20 MHz channel of the 100 MHz transmission is the 20 MHz subband.

In some examples, a preamble of the 100 MHz transmission indicates a punctured channel configuration of an entirety of the 160 MHz PPDU bandwidth; or the preamble indicates a punctured and unpunctured channel configuration of an entirety of the 80 MHz subband or a subset of 20 MHz subchannels of the entirety of the 80 MHz subband.

In some examples, the 100 MHz transmission is an orthogonal frequency division multiple access transmission or a non-orthogonal frequency division multiple access multi-user MIMO transmission. In some examples, a subsequent signal field after a universal signal field in a preamble of the 100 MHz transmission uses a single content channel structure for the 100 MHz transmission.

In some examples, a (996)+(242) tone multiple resource unit for the 100 MHz transmission, a (484+242)+(242) tone multiple resource unit for the 100 MHz transmission, or a (484)+(242) tone multiple resource unit for the 100 MHz transmission.

In some examples, a first segment parser operation is associated with the (996)+(242) tone multiple resource unit. In some examples, a second segment parser operation is associated with the (484+242)+(242) tone multiple resource unit. In some examples, a third segment parser operation is associated with the (484)+(242) tone multiple resource unit.

In some examples, the frequency resource allocation information includes a punctured channel information field, and the punctured channel information field indicates at least one of: a [1 1 1 1 1 x x x] puncturing pattern associated with a (996)+(242) tone multiple resource unit; a [x 1 1 1 1 x x x], [1×1 1 1 x x x], [1 1 x 1 1 x x x], or [1 1 1×1 xxx] puncturing pattern associated with a (484+242)+(242) tone multiple resource unit; or a [x x 1 1 1 x x x] or [1 1 x x 1 x x x] puncturing pattern associated with a (484)+(242) tone multiple resource unit.

In some examples, the 100 MHz transmission is a non-orthogonal frequency division multiple access transmission or a non-orthogonal frequency division multiple access single user transmission.

In some examples, to support communicating the frequency resource allocation information, the trigger frame manager 945 is configurable or configured to receive a trigger frame including the frequency resource allocation information.

In some examples, the 100 MHz transmission capability manager 950 is configurable or configured to transmit, to a second wireless communications device, a message including at least one of: a field indicative of a capability of the wireless communications device to support both 100 MHz transmission and 100 MHz reception, a field indicative of a capability of the wireless communications device to support 100 MHz transmission, or a field indicative of a capability of the wireless communications device to support 100 MHz reception, and where communication of the frequency resource allocation information is in association with the message.

In some examples, the 100 MHz transmission capability manager 950 is configurable or configured to receive, from the second wireless communications device, a second message including at least one of: a field indicative of a capability of the second wireless communications device to support both 100 MHz transmission and 100 MHz reception, a field indicative of a capability of the second wireless communications device to support 100 MHz transmission, or a field indicative of a capability of the second wireless communications device to support 100 MHz reception, and where communication of the frequency resource allocation information is in association with the second message.

FIG. 10 shows a flowchart illustrating an example process 1000 performable by or at a wireless communications device that supports 100 MHz transmission. The operations of the process 1000 may be implemented by a wireless communications device or its components as described herein. For example, the process 1000 may be performed by a wireless communication device, such as the wireless communication device 900 described with reference to FIG. 9, operating as or within a wireless AP or a wireless STA. In some examples, the process 1000 may be performed by a wireless AP or a wireless STA, such as one of the APs 102 or the STAs 104 described with reference to FIG. 1.

In some examples, in 1005, the wireless communications device may communicate a beacon frame indicative of a country code associated with a 160 MHz physical layer protocol data unit (PPDU) bandwidth within a defined bandwidth. The operations of 1005 may be performed in accordance with examples as disclosed herein. In some implementations, aspects of the operations of 1005 may be performed by a beacon frame manager 925 as described with reference to FIG. 9.

In some examples, in 1010, the wireless communications device may communicate, in association with the country code, frequency resource allocation information for a 100 MHz transmission within the 160 MHz PPDU bandwidth, the 100 MHz transmission including an 80 MHz subband and a 20 MHz subband. The operations of 1010 may be performed in accordance with examples as disclosed herein. In some implementations, aspects of the operations of 1010 may be performed by a frequency resource allocation information manager 930 as described with reference to FIG. 9.

In some examples, in 1015, the wireless communications device may transmit a payload of the 100 MHz transmission in accordance with the frequency resource allocation information. The operations of 1015 may be performed in accordance with examples as disclosed herein. In some implementations, aspects of the operations of 1015 may be performed by a 100 MHz transmission manager 935 as described with reference to FIG. 9.

Implementation examples are described in the following numbered clauses:

Aspect 1: A method for wireless communications by a wireless communications device, including: communicating a beacon frame indicative of a country code associated with a 160 MHz PPDU bandwidth within a defined bandwidth; communicating, in association with the country code, frequency resource allocation information for a 100 MHz transmission within the 160 MHz PPDU bandwidth, the 100 MHz transmission including an 80 MHz subband and a 20 MHz subband; and transmitting a payload of the 100 MHz transmission in accordance with the frequency resource allocation information.

Aspect 2: The method of aspect 1, where communicating the frequency resource allocation information includes: transmitting the frequency resource allocation information in a preamble of the 100 MHz transmission.

Aspect 3: The method of any of aspects 1-2, where the 80 MHz subband is a lower frequency band than the 20 MHz subband, and a primary 20 MHz channel of the 100 MHz transmission is located within the 80 MHz subband.

Aspect 4: The method of any of aspects 1-3, where the 80 MHz subband is a lower frequency band than the 20 MHz subband, and a primary 20 MHz channel of the 100 MHz transmission is the 20 MHz subband.

Aspect 5: The method of aspect 4, where a preamble of the 100 MHz transmission indicates a punctured channel configuration of an entirety of the 160 MHz PPDU bandwidth; or the preamble indicates a punctured and unpunctured channel configuration of an entirety of the 80 MHz subband or a subset of 20 MHz subchannels of the entirety of the 80 MHz subband.

Aspect 6: The method of any of aspects 4-5, where the 100 MHz transmission is an OFDMA transmission or a non-OFDMA multi-user MIMO transmission, and a subsequent signal field after a universal signal field in a preamble of the 100 MHz transmission uses a single content channel structure for the 100 MHz transmission.

Aspect 7: The method of any of aspects 1-6, where the frequency resource allocation information indicates at least one of a (996)+(242) tone MRU for the 100 MHz transmission, a (484+242)+(242) tone MRU for the 100 MHz transmission, or a (484)+(242) tone MRU for the 100 MHz transmission.

Aspect 8: The method of aspect 7, where a first segment parser operation is associated with the (996)+(242) tone MRU, a second segment parser operation is associated with the (484+242)+(242) tone MRU, and a third segment parser operation is associated with the (484)+(242) tone MRU.

Aspect 9: The method of any of aspects 1-8, where the frequency resource allocation information includes a punctured channel information field, and where the punctured channel information field indicates at least one of: a [1 1 1 1 1 x x x] puncturing pattern, associated with a (996)+(242) tone MRU; a [x 1 1 1 1 x x x], [1×1 1 1 x x x], [1 1×11 xxx], or [1 1 1×1 xxx] puncturing pattern, associated with a (484+242)+(242) tone MRU; or a [x x 1 1 1 x x x] or [1 1 x x 1 x x x] puncturing pattern, associated with a (484)+(242) tone MRU.

Aspect 10: The method of aspect 9, where the 100 MHz transmission is a non-OFDMA transmission or a non-OFDMA single user transmission.

Aspect 11: The method of any of aspects 1 or 3-10, where communicating the frequency resource allocation information includes: receiving a trigger frame including the frequency resource allocation information.

Aspect 12: The method of any of aspects 1-11, further including: transmitting, to a second wireless communications device, a message including at least one of: a field indicative of a capability of the wireless communications device to support both 100 MHz transmission and 100 MHz reception, a field indicative of a capability of the wireless communications device to support 100 MHz transmission, or a field indicative of a capability of the wireless communications device to support 100 MHz reception, and where communication of the frequency resource allocation information is in association with the message.

Aspect 13: The method of aspect 12, further including: receiving, from the second wireless communications device, a second message including at least one of: a field indicative of a capability of the second wireless communications device to support both 100 MHz transmission and 100 MHz reception, a field indicative of a capability of the second wireless communications device to support 100 MHz transmission, or a field indicative of a capability of the second wireless communications device to support 100 MHz reception, and where communication of the frequency resource allocation information is in association with the second message.

Aspect 14: A wireless communications device for wireless communications, including a processing system that includes processor circuitry and memory circuitry that stores code, the processing system configured to cause the wireless communications device to perform a method of any of aspects 1-13.

Aspect 15: A wireless communications device for wireless communications, including at least one means for performing a method of any of aspects 1-13.

Aspect 16: A non-transitory computer-readable medium storing code for wireless communications, the code including instructions executable by one or more processors to perform a method of any of aspects 1-13.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communications device, comprising:
a processing system that includes processor circuitry and memory circuitry that stores code, the processing system configured to cause the wireless communications device to:
communicate a beacon frame indicative of a country code associated with a 160 MHz physical layer protocol data unit (PPDU) bandwidth within a defined bandwidth;
communicate, in association with the country code, frequency resource allocation information for a 100 MHz transmission within the 160 MHz PPDU bandwidth, the 100 MHz transmission comprising an 80 MHz subband and a 20 MHz subband; and
transmit a payload of the 100 MHz transmission in accordance with the frequency resource allocation information.

2. The wireless communications device of claim 1, wherein, to communicate the frequency resource allocation information, the processing system is configured to cause the wireless communications device to:
transmit the frequency resource allocation information in a preamble of the 100 MHz transmission.

3. The wireless communications device of claim 1, wherein:
the 80 MHz subband is a lower frequency band than the 20 MHz subband, and
a primary 20 MHz channel of the 100 MHz transmission is located within the 80 MHz subband.

4. The wireless communications device of claim 1, wherein:
the 80 MHz subband is a lower frequency band than the 20 MHz subband, and
a primary 20 MHz channel of the 100 MHz transmission is the 20 MHz subband.

5. The wireless communications device of claim 4, wherein a preamble of the 100 MHz transmission indicates a punctured channel configuration of an entirety of the 160 MHz PPDU bandwidth; or the preamble indicates a punctured and unpunctured channel configuration of an entirety of the 80 MHz subband or a subset of 20 MHz subchannels of the entirety of the 80 MHz subband.

6. The wireless communications device of claim 4, wherein:
the 100 MHz transmission is an orthogonal frequency division multiple access transmission or a non-orthogonal frequency division multiple access multi-user MIMO transmission, and
a subsequent signal field after a universal signal field in a preamble of the 100 MHz transmission uses a single content channel structure for the 100 MHz transmission.

7. The wireless communications device of claim 1, wherein:
a (996)+(242) tone multiple resource unit for the 100 MHz transmission, a (484+242)+(242) tone multiple resource unit for the 100 MHz transmission, or a (484)+(242) tone multiple resource unit for the 100 MHz transmission.

8. The wireless communications device of claim 7, wherein:
a first segment parser operation is associated with the (996)+(242) tone multiple resource unit,
a second segment parser operation is associated with the (484+242)+(242) tone multiple resource unit, and
a third segment parser operation is associated with the (484)+(242) tone multiple resource unit.

9. The wireless communications device of claim 1, wherein, to, the processing system is configured to cause the wireless communications device to:
a [1 1 1 1 1 x x x] puncture pattern, associated with a (996)+(242) tone multiple resource unit; a [x 1 1 1 1 x x x], [1×1 1 1 x x x], [1 1 x 1 1 x x x], or [1 1 1 x 1 x x x] puncturing pattern, associated with a (484+242)+(242) tone multiple resource unit; or a [x x 1 1 1 x x x] or [1 1 x x 1 x x x] puncturing pattern, associated with a (484)+(242) tone multiple resource unit.

10. The wireless communications device of claim 9, wherein the 100 MHz transmission is a non-orthogonal frequency division multiple access transmission or a non-orthogonal frequency division multiple access single user transmission.

11. The wireless communications device of claim 1, wherein, to communicate the frequency resource allocation information, the processing system is configured to cause the wireless communications device to:
receive a trigger frame comprising the frequency resource allocation information.

12. The wireless communications device of claim 1, wherein the processing system is further configured to cause the wireless communications device to:
transmit, to a second wireless communications device, a message comprising at least one of: a field indicative of a capability of the wireless communications device to support both 100 MHz transmission and 100 MHz reception, a field indicative of a capability of the wireless communications device to support 100 MHz transmission, or a field indicative of a capability of the wireless communications device to support 100 MHz reception, and wherein communication of the frequency resource allocation information is in association with the message.

13. The wireless communications device of claim 12, wherein the processing system is further configured to cause the wireless communications device to:
receive, from the second wireless communications device, a second message comprising at least one of: a field indicative of a capability of the second wireless communications device to support both 100 MHz transmission and 100 MHz reception, a field indicative of a capability of the second wireless communications device to support 100 MHz transmission, or a field indicative of a capability of the second wireless communications device to support 100 MHz reception, and wherein communication of the frequency resource allocation information is in association with the second message.

14. A method for wireless communications by a wireless communications device, comprising:
communicating a beacon frame indicative of a country code associated with a 160 MHz physical layer protocol data unit (PPDU) bandwidth within a defined bandwidth;
communicating, in association with the country code, frequency resource allocation information for a 100 MHz transmission within the 160 MHz PPDU bandwidth, the 100 MHz transmission comprising an 80 MHz subband and a 20 MHz subband; and
transmitting a payload of the 100 MHz transmission in accordance with the frequency resource allocation information.

15. The method of claim 14, wherein communicating the frequency resource allocation information comprises:
transmitting the frequency resource allocation information in a preamble of the 100 MHz transmission.

16. The method of claim 14, wherein:
the 80 MHz subband is a lower frequency band than the 20 MHz subband, and
a primary 20 MHz channel of the 100 MHz transmission is located within the 80 MHz subband.

17. The method of claim 14, wherein:
the 80 MHz subband is a lower frequency band than the 20 MHz subband, and
a primary 20 MHz channel of the 100 MHz transmission is the 20 MHz subband.

18. The method of claim 17, wherein the 100 MHz transmission is an orthogonal frequency division multiple access transmission, and wherein a preamble of the 100 MHz transmission indicates a punctured channel configuration of an entirety of the 160 MHz PPDU bandwidth; or the preamble indicates a punctured and unpunctured channel configuration of an entirety of the 80 MHz subband or a subset of 20 MHz subchannels of the entirety of the 80 MHz subband.

19. The method of claim 17, wherein:
the 100 MHz transmission is an orthogonal frequency division multiple access transmission or a non-orthogonal frequency division multiple access multi-user MIMO transmission, and
a subsequent signal field after a universal signal field in a preamble of the 100 MHz transmission uses a single content channel structure for the 100 MHz transmission.

20. A non-transitory computer-readable medium storing code for wireless communications, the code comprising instructions executable by one or more processors to:
communicate a beacon frame indicative of a country code associated with a 160 MHz physical layer protocol data unit (PPDU) bandwidth within a defined bandwidth;
communicate, in association with the country code, frequency resource allocation information for a 100 MHz transmission within the 160 MHz PPDU bandwidth, the 100 MHz transmission comprising an 80 MHz subband and a 20 MHz subband; and
transmit a payload of the 100 MHz transmission in accordance with the frequency resource allocation information.
